(19) United States
(12) Patent Application Publication
(10) Pub. No.: US 2003/0124975 A1
(43) Pub. Date: Jul. 3, 2003

(54) Global positioning system (GPS) with cellular infrastructure

(76) Inventors: Alon Ram, Herzlia (IL); Yehudit Levi, Tel Aviv (IL)

Correspondence Address: Eitan, Pearl, Latzer & Cohen-Zedek, LLP., 10 ROCKEFELLER PLAZA, SUITE 1001, NEW YORK, NY, 10020, US

(21) Appl. No.: 10/032,148

(22) Filed: Dec. 31, 2001

(51) Int. Cl. H04B 7/185

(52) U.S. Cl. 455/12.1; 455/427

(57) ABSTRACT

In one embodiment of the invention, there is a mobile unit having a GPS receiver to receive at least one signal from at least one satellite, a communication transceiver to communicate with a base station, and a data bus connected to the GPS receiver and the communication transceiver. The bus may carry a signal tom the GPS receiver to a memory unit and may carry data from the communication transceiver to an audio/video apparatus.

### BACKGROUND OF THE INVENTION

Position determination may be performed using a global positioning system (GPS). In a GPS system, a plurality of satellites may transmit GPS signals on a code division multiple access (CDMA) channel. A GPS mobile unit may receive the GPS signals, decode the signals from three or more satellites and derive the distance to these three or more satellites from the decoded signals. According to the distances, the GPS mobile unit may calculate its position. The signals transmitted from the satellites may generally include the identity and position of the satellite transmitting the signals. In addition, the transmitted signals may include the time at which the signals were transmitted, such that the receiving mobile unit can determine the distance between the mobile unit and the satellite.

The Telecommunication Industry Association/Electronics Industry Association (TIA/EIA) IS-801 standard, entitled “Position Determination Service Standard for Dual Mode Spread Spectrum Systems”, describes a GPS system in which the calculations are performed in conjunction by a GPS mobile unit and a base station of a cellular network. According to the standard, the mobile unit may receive signals from one or more satellites, determine the distances from Me mobile unit to the one or more satellites, and pass these distances to the base station. The base station may calculate the position of the mobile unit from the supplied distances and may notify the cellular unit accordingly. In addition, the base station may supply the mobile unit with coding information which may simplify the identification and decoding of the satellite signals by the mobile unit.

Mobile units which operate in accordance with the IS-801 standard may include two separate communication modules. A first module may receive the GPS signals and a second module may communicate with the base station. It has been suggested to use shared radio frequency (RF) to intermediate frequency (IF) and analog-to-digital (A/D) converters for signal reception modules. Another suggestion is to use a single processor to manipulate the transmitted and received signals of both the modules.

### BRIEF DESCRIPTION OF FIGURES

The subject matter regarded as the invention is particularly pointed out and distinctly claimed in the concluding portion of the specification. The invention, however, both as to organization and method of operation, together with objects, features, and advantages hereof, may best be understood by reference to the following detailed description when read with the accompanying drawings in which;

FIG. 1 is a schematic block diagram of a mobile unit which operates as both a cellular phone and a GPS unit, in accordance with an exemplary embodiment of the present invention;

FIG. 2 is a schematic diagram of the software and hardware operational units of a processing unit of a mobile unit, in accordance with an embodiment of the present invention;

FIG. 3 is a flowchart of the actions performed by a mobile unit in determining its location, in accordance with an embodiment of the present invention; and

FIG. 4 is a flowchart of the acts performed in using a bus of a mobile unit, in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements,

### DETAILED DESCRIPTION OF EMBODIMENTS

In the following detailed description, numerous specific details are set forth in order to provide a thorough understanding of the, invention. However, it will be understood by those skilled in the art that the present invention may be practiced without these specific details. In other instances, well-known methods, procedures, components and circuits have not been described in detail so as not to obscure the present invention.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition embodiments of the present invention are not described with reference to any particular programming language. It will be appreciated that a variety of programming languages may be used to implement the teachings of the inventions as described herein.

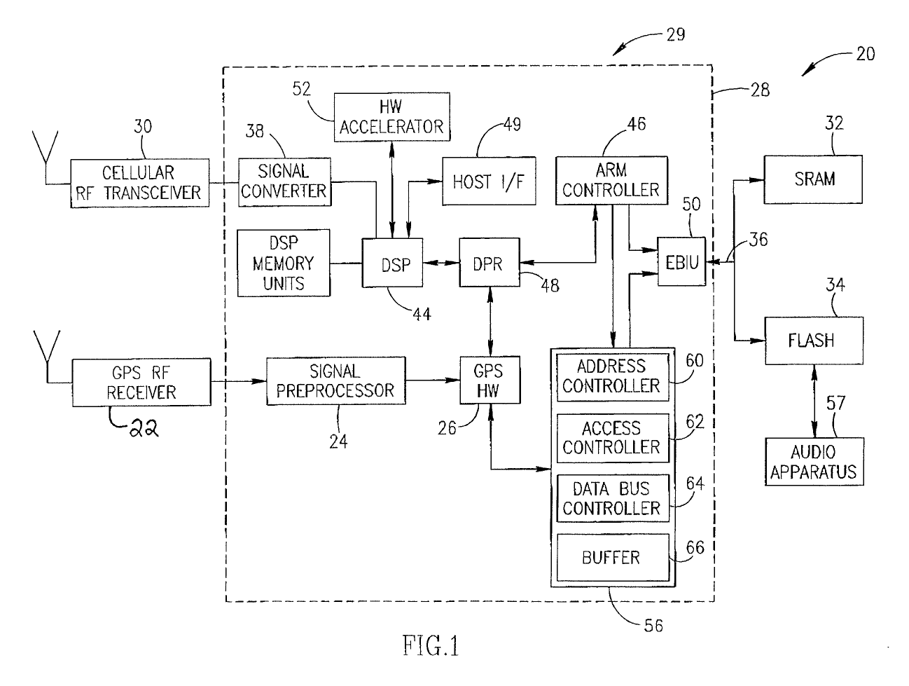

Turning flow to FIG. 1, there is shown a schematic block diagram of a mobile unit 20, in accordance with an embodiment of the present invention. Mobile unit 20 may operate as both a cellular communication device (e.g. cell phone) and as a GPS unit, sharing some of the hardware resources of the mobile unit for both cellular communications and position, determination. Mobile unit 20 may have a GPS RF receiver 22 coupled to an antenna, which may receive satellite signals used for location determination, and a cellular RF transceiver 30 coupled to an antenna, which may communicate, for example, with a cellular base station. The cellular base station may be, for example, a code division multiple access (CDMA) base station or a time division multiple access (TDMA) base station. The antenna may be a dipole antenna, a shot antenna, a dual antenna, an omni-directional antenna, a loop antenna or any other suitable antenna type, although the scope of the present invention is not limited in this respect.

A base-band processing unit 28 may perform processing of transmitted and received signals passing through transceiver 30. In some embodiments of the invention, processing unit 28 may be located on a single chip 29. The use of a single chip 29 for hosting all the components of processing unit 28 may reduce the production costs of mobile unit 20. In addition, processing unit 28 may perform location calculations based on satellite signals received by receiver 22.

Processing unit 28 may comprise an external bus interface unit (EBIU) 50, through which processing unit 28 may transfer cellular data signals (e.g., telephone signals) to, and may receive telephone signals from, audio apparatus 57 (e.g., speaker, microphone) of mobile unit 20. Optionally, the signals to and from audio apparatus 57 may be passed through a flash buffer memory 34. In some embodiments of the invention, mobile unit 20 may have a large memory unit, for example, a static random access memory (SRAMI) 32 in which satellite signals received by receiver 22 may be stored for processing. Optionally, SRAM 32 may have at least 4 Mbytes of storage space for storing the satellite signals. The use of SLAM 32 external to chip 29, may reduce the cost of production of mobile unit 20, since including a large memory unit within a single chip with processing unit 28 may make the size of the chip exceed the economical size of chips. Audio apparatus 57 may be an audio/video apparatus with a visual display.

In some embodiments of the invention, PBIU 50 is used both for accessing flash memory 34 and SRAM 32. In some embodiments of the invention, a combined bus 36 connects base-band processing unit 28 to SRAM 32 and to flash memory 34. Te use of a combined bus and bus interface reduces the size, weight and cost of mobile unit 20.

Base-band processing unit 28 may comprise standard elements included in processing units of cellular phones. These elements include, a signal converter 38 which performs analog to digital and digital to analog conversion of signals passing through transceiver 30, a digital signal processing (ASP) processor 44, a controller 46, and a dual port register (DPR) 48 for transferring data to DSP processor 44. Controller 46 may be, for example, a handset controller commercially available from ARM Ltd. of Cambridge, England. A host interface (I/F) 49 is optionally used to communicate between controller 46 and DSP 44.

In addition, processing unit 28 may have a signal preprocessor 24 which may include an analog-to-digital (A/D) converter (not shown) and which may convert the satellite signals from receiver 22 to digital form. Optionally, signal preprocessor 24 may also perform automatic gain control (AGC) and direct current (DC) removal. The preprocessed signals may be provided to a GPS hardware unit 26 which may perform initial digital processing of the GPS signals.

In addition to performing tasks for cellular communication, DSP processor 44 and controller 46 may perform some tasks for position or location determination In some embodiments of the invention, mobile unit 20 may have a hardware calculation unit, such as a butterfly fast Fourier Transform (FFT) hardware accelerator 52. The use of hardware accelerator 52 may reduce the load on DSP 44 and may be particularly useful when DSP 44 performs processing tasks relating to both GPS signals and to cellular communication signals.

A GPS hardware external interface 56 may mediate between EBIU 50 and GPS hardware 26, as described hereinbelow In some embodiments of the invention, GPS hardware external interface 56 may have an address controller 60, an access controller 62 and a data controller 64. Optionally, data controller 64 may have a double read write (Rd/Wr) buffer 66 for storing the data while waiting when bus 36 is busy, as described hereinbelow. In some embodiments of the invention, the size of buffer 66 is sufficient to store the satellite signals received during a period in which the bus is used for transferring signals for cellular transmission or reception. In an exemplary embodiment of the present invention, buffer 66 may have room for 16 words of 16 bits.

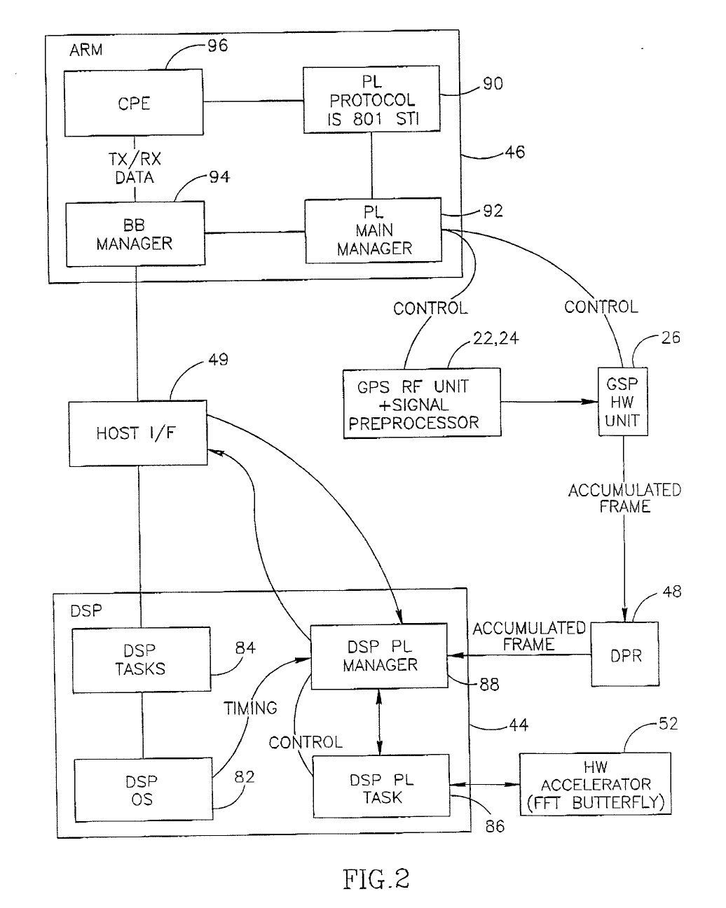

Turning now to FIG. 2, there is shown a schematic diagram of the software and hardware operational units of processing unit 28, hi accordance with an embodiment of the present invention. DSP 44 may run one or more communication DSP tasks 84 which handle communication signals transmitted or received by transceiver 30. Tasks 84 may perform signal detection, equalization, decoding and/or any other tasks as or known in the art. In addition, DSP 44 may run a position location (PL) task 86 which determines the pseudo ranges of the satellites, optionally, with the aid of hardware accelerator 52. Optionally, DSP 44 also may run a position location (PL) manager 88 which may receive the data used by PL task 86 and operational instructions, and accordingly may initiate the operation of PL task 86. A DSP operating system (OS) 82 may distribute the processing time of DSP 44 between DSP tasks 84 and DSP PL manager 88.

Controller 46 may run a base-band manager 94 and a call processing engine (CPE) 96 which may transmit and receive control messages to/from a cellular base station and accordingly control mobile unit 20. In some embodiments of the invention, controller 46 may run a position location (PL) protocol 90 (e.g location protocol STI) which may communicate with a GPS server of the base station through CPB 96. Controller 46 may also run a PL main manager 92 which manages the operation of position location of mobile unit 20. In some embodiments of the invention, PL manager 92 controls GPS RF receiver 22, preprocessor 24 and GPS hardware unit 26. Optionally, PL manager 92 may also control the position location tasks of DSP 44, for example, by transmitting commands to PL manager 88 through BB manager 94 and host I/F 49. In some embodiments of the invention, PL protocol 90 may receive the calculation results of DSP PL task 86 through host I/F 49 and may prepare them for transmission through CPE 96 and BB manager 94. In some embodiments of the invention, PL manager 92 may be capable of preventing transmissions on transceiver 30, such that while receiver 22 is operating in receiving signals, transceiver 30 does not transmit signals which may interfere with the reception of the satellite signals.

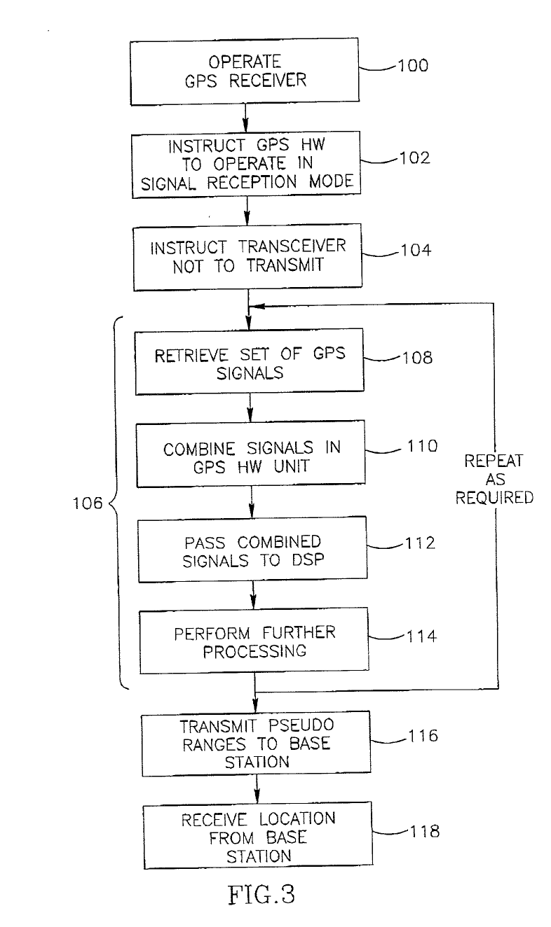

Turning now to FIG. 3, there is shown a flowchart of the actions performed by mobile 20 in determining its location, in accordance with an embodiment of the present invention. In response to a command to determine the location, controller 46 operates (100) GPS RF receiver 22 and signal preprocessor 24 which may receive satellite signals for a predetermined period, e.g., 1 second. The command to determine the location may be received through a user interface of mobile 20 and/or from the base station servicing mobile 20. Controller 46 may also instruct (102) GPS hardware unit 26 to operate in a signal receiving mode in which the signals are received from signal preprocessor 24 and are passed for storage to SRAM 32 via EBIU 50 and combined bus 36. Optionally, controller 46 may instruct (104) transceiver 30 not to transmit signals during the GPS signal reception period, so as not to interfere with the received signals which may have a relatively low amplitude. It is noted that during the GPS signal reception period, transceiver 30 may receive signals which are decompressed and/or decoded by DSP 44 and may transfer these signals to flash memory 34. Also, signals from flash memory 34 may be passed to DSP 44 for processing, for example in preparation for transmission. The distribution of the use of combined bus 36 between GPS hardware unit 26 and DSP 44 may be governed by controller 46 as described in further detail below.

After the GPS signals received during he predetermined period are stored in SRAM 32, controller 46 may instruct GPS hardware unit 26 to move to a processing mode (106). The following exemplary description of the operations performed during processing mode (106) relate to the elements of mobile unit 20 which perform the various tasks of the processing mode and do not relate to the calculations themselves which are known in the art. In the processing mode (106), controller 46 may retrieve (108) sets of GPS signals from SRAM 32. The retrieved signals may be added (110) to each other by GPS hardware unit 26 and the resulting sums (referred to as accumulated frames) may be passed (112) to DSP 44 via DPR 48 for further processing. DSP 44 may perform farther processing (114) of the sums in which pseudo distances from GPS satellites are determined. In some embodiments of the inventor, some of the Fixer processing (114) is performed by hardware accelerator 52 In some embodiments of the invention, the farther processing (114) of the satellite signals may be performed by DSP processor 44 concurrently with calculations performed on transmitted and/or received cellular signals.

The pseudo ranges may then be transmitted (116) by transceiver 30 to a cellular base station where the location of mobile unit 20 may be calculated responsive to the pseudo ranges. The base station may transmit the location back to mobile unit 20.

Mobile unit 20 may then receive (118) a message which includes the location of the mobile unit from the cellular base station. The location of the mobile unit may then be displayed (80) to a user of mobile unit 20.

In an exemplary embodiment of the invention, when receiver 22 and hardware unit 26 operate in the signal receiving mode, hardware unit 26 may generate about 4 Mbits of data which may be stored in SRAM 32. If, for example, bus 36 has a maximal bus load of 10 MHz the storage of the data in SRAM 32 may use about 2.5% of the bus capacity. During processing mode (106), reading of data from SRAM 32 may use about 6.5% of the bus capacity. Thus, during the read and write operations of hardware unit 26, bus 36 may be used for transmission of data between processing unit 28 and flash memory 34.

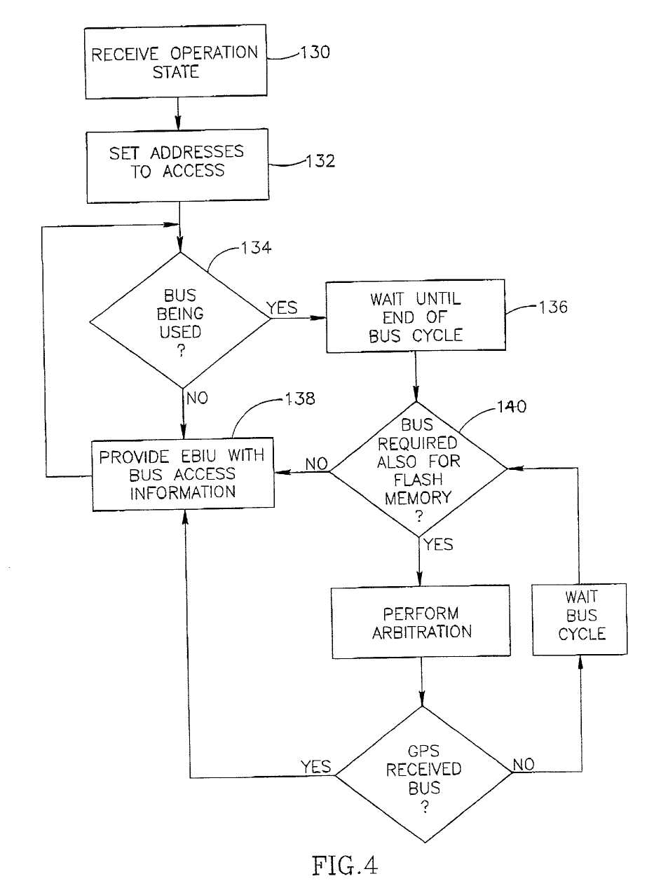

Turning now to FIG. 4, there is shown a flowchart of the acts performed in using bus 36 by GPS interface 56, in accordance with an embodiment of the present invention. GPS interface may receive (130) instructions from PL manager 92 on controller 46 regarding the operation state of the GPS interface. In an exemplary embodiment of the present invention, GPS interface 56 may be in au off mode, a satellite signal reception mode in which the interface stores signals in SRAM 32, and a GPS processing mode in which GPS interface 56 retrieves data from SRAM 32. In the signal reception mode and/or the processing mode, PL main manager 92 also optionally instructs (132) address controller 60 on the addresses to be accessed in SRAM 32. In some embodiments of the invention, address controller 60 keeps track of a current storage address to be used in storing the satellite data to SRAM 32.

In some embodiments of the invention, one or more times during the satellite signal receiving state, PL manager 92 may provide address controller 60 with beginning and ending addresses of the area in SRAM 32 in which the signals provided by GPS hardware unit 26 are to be stored. Optionally, the addresses may be provided once for an entire satellite signal receiving state. Alternatively, the addresses are provided periodically for predetermined data chunks. After a data word is stored, the current storage address is optionally immediately incremented for preparation for a next storage cycle. Alternatively, the current storage address may be updated at any other time, for example, before the address is to be used. Optionally, whenever a data word is ready for storage in SRAM 32, the data word may be provided to buffer 66 and may be stored at a location instructed by data bus controller 64.

During the GPS processing mode, when data is used for processing, PL main manager 92 may provide address controller 60 with a list of the addresses for a current calculation. Address controller 60 may pass consecutively over the list of addresses retrieving the contents of the address until the contents of the addresses are provided to GPS hardware unit 26. Alternatively, address controller may receive the addresses from GPS hardware unit 26 one at a time, optionally after the data from the previous address may be stored in buffer 66.

When buffer 66 has data to be stored during the satellite signal reception mode and/or when address controller 60 has one or more addresses from which it did not read data yet, access controller 62 of GPS interface 56 may determine (134) whether bus 36 is being used by processor 46 for communication with flash memory 34. If (134) bus 36 is busy handling a data transfer from flash memory 34, GOS interface 56 may wait (136) until the end of the current cycle of the bus. If (140) at the end of the current cycle, both GPS interface 56 and controller 46 request control of the bus, an arbitration method may be executed to determine which module is to receive control over the bus during the next bus cycle. If GPS interface 56 does not receive control of bus 36, GPS interface 56 may wait for the next bus cycle and again contend for control of bus 36.

If the bus is not in use, or GPS interface 56 receives control of bus 36 in accordance with the arbitration method, address controller 60 may provide (138) EBIU 50 with the current access address, data bus controller 64 may provide EBIU 50 with a current word to be stored, from buffer 66 and access controller 62 may indicate EBIU 50 whether a read or write operation is desired.

Many arbitration methods may be used in determining which module receives control of bus 36 during a specific bus cycle. In some embodiments of the invention, the arbitration method depends on the amount of room in buffer 66 and/or whether GPS interface 56 is performing a read or write operation.

In some embodiments of the invention, during the satellite reception mode, precedence is given to GPS interface 56 when more than a predetermined percent (e.g., between 50-75%) of buffer 66 is full with data which needs to be stored. Alternatively or additionally, GPS interface 56 receives precedence when it has not received the bus for over a predetermined number of cycles. Generally, communication data takes priority over GPS related data.

It is noted that although the above description shows mobile unit 20 as including separate RF units for the satellite signals and for the cellular signals, e.g., receiver 22 and transceiver 30, in some embodiments of the invention a single transceiver may be used for both the satellite signals and the cellular signals. Furthermore, in some embodiments of the invention, the tasks of signal preprocessor 24 and of converter 38 may be performed by a single unit.

It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. Variations of embodiments described will occur to persons of the art. It is, therefore, to be understood that the appended claims are intended to cover al such modifications and changes as fall within the true spirit of the invention.

What is claimed is:

1. A mobile unit comprising:
a global positioning system (GPS) receiver to receive at least one signal from at least one satellite;
a communication transceiver to communicate with a base station; and
a data bus to carry a signal from said GPS receiver to a memory unit and to carry data from said communication transceiver to an audio/video apparatus.

2. The mobile unit according to claim 1, further comprising a controller able to regulate communication between the mobile unit and the base station.

3. The mobile unit according to clan 2, further comprising a GPS hardware unit to calculate pseudo-range information from the at least one satellite signal.

4. The mobile unit according to claim 3, further comprising a digital signal processor to process the communication signal.

5. The mobile unit according to claim 4, wherein the digital signal processor performs pseudo range calculations.

6. The mobile unit according to claim 5, further comprising a processing accelerator to perform part of said pseudo range calculations.

7. The mobile unit according to claim 3, wherein said communication transceiver transmits the pseudo range data to the base station.

8. The mobile unit according to claim 7, wherein said communication transceiver receives position data from the base station.

9. The mobile unit according to claim 1, wherein the communication transceiver does not transmit while the GPS receiver is receiving a signal.

10. The mobile unit according to claim 1, wherein the audio/video apparatus is a speaker or a visual display.

11. A system for determining location comprising:
a mobile unit comprising:
a GPS receiver to receive a signal from a satellite;
a dipole antenna;
a communication transceiver to communicate with a base station via said dipole antenna; and
a data bus to carry a signal from said OPS receiver to a memory unit and to carry data from said communication transceiver to an audio/video apparatus; and
a time division multiple access base station to communicate with said mobile unit and to calculate a position of said mobile unit based on data received from said mobile unit.

12. The system according to claim 11, further comprising a controller to regulate communication between the mobile unit and the base station.

13. The system according to claim 12, further comprising a GPS hardware unit to calculate pseudo-range information from the satellite signal.

14. The system according to claim 13, father comprising a digital signal processor to process the communication signal.

15. The system according to claim 14, wherein the digital signal processor performs pseudo range calculations.

16. The system according to claim 15, further comprising a processing accelerator to perform part of said pseudo range calculations.
